(19) United States
(12) Patent Application Publication
(10) Pub. No.: US 2024/0326349 A1
(43) Pub. Date: Oct. 3, 2024

(54) BONDING METHOD AND APPARATUS

(71) Applicant: Henkel AG & KGaA, Düsseldorf (DE)

(72) Inventors: WeiJia Lin, Suzhou (CN); YanSheng Qiu, Shanghai (CN)

(21) Appl. No.: 18/743,317

(22) Filed: Jun. 14, 2024

Related U.S. Application Data
(63) Continuation of application No. PCT/CN2021/139043, filed on Dec. 17, 2021.

(51) Int. Cl. B29C 65/00; B29C 65/48; B29C 65/52

(52) U.S. Cl. CPC B29C 66/61; B29C 65/483; B29C 65/524; B29C 66/95

(57) ABSTRACT

The present application discloses a method and an apparatus for bonding a first object with a second object, the first object being elongated, the second object being defined with a cavity configured to receive at least a length of the first object, the cavity having a receiving capacity which is slightly greater than a volume of the first object to be inserted into the cavity, and the cavity being configured to include a closed end and an opposite open end. The method comprising: determining an amount of liquid adhesive to be supplied into the cavity on the basis of the difference between the receiving capacity of the cavity and the volume of the first object to be inserted into the cavity; placing the second object in such a way that the closed end is on bottom and the open end is on top; supplying the determined amount of liquid adhesive into the cavity in such a way that the supplied liquid adhesive is collected at the closed end; inserting the first object into the cavity via the open end in such a way that one end of the first object approaches or contacts the closed end; and curing the liquid adhesive.

### FIELD

The present application generally relates to the technical field of inserting one elongated object into another object and bonding both of them.

### BACKGROUND

If one elongated object is required to be inserted into another object and then bonded with the same via an adhesive, a traditional approach is to apply a certain amount of adhesive onto an outer surface of the elongated object to be inserted, and then insert the elongated object already applied with the adhesive on its outer surface into a corresponding elongated hole of the another object, such that the two objects may be securely bonded together after the adhesive is cured. However, for the traditional approach, during insertion of the elongated object into the another object, the adhesive already applied on the outer surface of the elongated objection will be blocked by an exposed end face of the elongated hole of the another object, such that most of the already applied adhesive cannot enter the elongated hole. First, this phenomenon will result in that if the elongated object is inserted in the elongated hole in place, insufficient adhesive will enter a gap between the surface of the elongated object and the elongated hole of the another object and then the adhesive, even if entering, will not be dispensed in the gap evenly and without air bubbles. In this case, after the adhesive is cured, voids will exist in the gap between the two objects and thus the bonding strength therebetween will be weak. Second, as most of the adhesive previously applied are blocked out of the gap between the two objects, the blocked adhesive will have to be thrown away as wastes, causing significant waste of the adhesive. Moreover, for mass production, this will lead to a great increase in manufacturing costs.

### SUMMARY

In order to solve the above issues, the present application is aimed at proposing an improved method and apparatus for dispensing an adhesive such that under the premise of saving as much adhesive as possible, one elongated object can be inserted into another objection and be securely bonded with the same by the adhesive.

According to one aspect of the present application, a method for bonding a first object with a second object is proposed, the first object being elongated, the second object being defined with a cavity configured to receive at least a length of the first object, the cavity having a receiving capacity which is slightly greater than a volume of the first object to be inserted into the cavity, and the cavity being configured to include a closed end and an opposite open end, the method comprising:
determining an amount of liquid adhesive to be supplied into the cavity on the basis of the difference between the receiving capacity of the cavity and the volume of the first object to be inserted into the cavity in place;
placing the second object in such a way that the closed end is on bottom and the open end is on top;
supplying the determined amount of liquid adhesive into the cavity in such a way that the supplied liquid adhesive is collected at the closed end;
inserting at least a part of the first object into the cavity via the open end in such a way that one end of the first object approaches or contacts the closed end; and
curing the liquid adhesive.

Optionally, inserting an injection pipe into the cavity to supply the liquid adhesive into the cavity; and removing the injection pipe from the cavity before the first object is inserted into the cavity.

Optionally, at the start of supplying the liquid adhesive into the cavity, a liquid injecting front end of the injection pipe is placed adjacent the closed end in such a way that a minor amount of liquid adhesive is first supplied into the cavity.

Optionally, with continuously supplying the liquid adhesive, a relative movement between the second object and the injection pipe is carried out in such a way that the closed end becomes far away from the liquid injecting front end and the liquid injecting front end is immersed always under the supplied liquid adhesive's liquid level.

Optionally, after the determined amount of liquid adhesive has been supplied into the cavity, no liquid adhesive exists on an inner wall of the cavity above the liquid level.

Optionally, the first object is inserted into the cavity in such a way that a longitudinal central axis of the first object is coaxial with a longitudinal central axis of the cavity.

Optionally, the first object is a metal core of a stylus, the closed end of the receiving cavity is defined by a pencil tip of the stylus, and the second object is a sleeve of the stylus.

Optionally, the cavity has a length and an internal diameter, the length is within a range of 100 to 170 mm and the internal diameter is within a range of 6 to 12 mm, and the injection pipe comprises an injection needle sized 16 G and 6 inch; preferably, wherein the length of the cavity is 150 mm and the internal diameter of the cavity is 7.1 mm.

Optionally, the second object is a hollow cylinder, which hollow cylinder is configured to include an open end portion, which is enclosed by another object to define the closed end, and an opposing open end portion to define the open end.

According to another aspect of the present application, an apparatus for bonding a first object with a second object is proposed, the first object being elongated, the second object being defined with a cavity configured to receive at least a length of the first object, the cavity having a receiving capacity which is slightly greater than a volume of the first object to be inserted into the cavity, and the cavity being configured to include a closed end and an opposite open end, the apparatus comprising:
a control module configured to store and execute a program for carrying out a method according to any one of claims 1 to 8;
an operating module configured to be in data connection with the control module and be controllable by the control module;
an adhesive injecting module configured to be in data connection with the control module and be controllable by the control module, wherein the adhesive injecting module comprises an injection device by which the liquid adhesive is able to be supplied into the cavity.

Optionally, the injection device comprises:
a liquid storage device for storing the liquid adhesive;
an adhesive valve coupled via a pipe to the liquid storage device downstream of the liquid storage device; and
an injection pipe configured to be in fluid communication with the adhesive valve downstream of the adhesive valve.

Optionally, the adhesive valve is configured to include a valve body and a valve element, a passage is defined in the valve body to deliver the liquid adhesive, the valve element is installed to intersect through the passage and is configured to be rotatable about its own longitudinal central axis between a first position, in which the liquid adhesive is allowed to flow through the passage, and a second position, in which the liquid adhesive is forbidden to flow through the passage.

Optionally, the first object is a metal core of a stylus, the closed end of the receiving cavity is defined by a pencil tip of the stylus, and the second object is a sleeve of the stylus.

Optionally, the cavity has a length and an internal diameter, the length is within a range of 100 to 170 mm and the internal diameter is within a range of 6 to 12 mm, and the injection pipe comprises an injection needle sized 16 G and 6 inch; preferably, wherein the length of the cavity is 150 mm and the internal diameter of the cavity is 7.1 mm.

According to another aspect of the present application, a stylus which is produced by the method already mentioned and/or the apparatus already mentioned is proposed.

Using the technical measures of the present application, it can be ensured that two objects can be securely bonded together in such a way that adhesive saving is maximized and at the same time the adhesive can be dispensed evenly between the two objects so as to improve the bonding durability therebetween.

### BRIEF DESCRIPTION OF THE DRAWINGS

The principles and other aspects of the present application will be well understood by the following description in combination of the attached drawings. It should be noticed that for clarify only the drawings may be given in different ratios, which will not affect understanding to the present application. In the drawings:

FIGS. 1A to 1C are views schematically illustrating a traditional method for bonding an elongated core into a hollow cylinder by an adhesive;

FIG. 2 is a flow chart schematically illustrating a method according to one embodiment of the present application, in which an elongated core is bonded into a hollow cylinder by an adhesive;

FIG. 3 is a view schematically illustrating a process of bonding and securing one elongated core into one hollow cylinder by the method as explained with respect to FIG. 2;

FIG. 4 is a block chart schematically illustrating an apparatus according to one embodiment of the present application for carrying out the method of the present application;

FIG. 5A is a view schematically illustrating an injection device according to one embodiment of the present application which can be used in the apparatus of FIG. 4; and

FIG. 5B is a view schematically illustrating an adhesive valve according to one embodiment of the present application which can be used in the method or apparatus of the present application.

### DETAILED DESCRIPTION OF SOME EMBODIMENTS

In the drawings of the present application, those features having the same configuration or similar functions may be represented by the same reference numerals respectively.

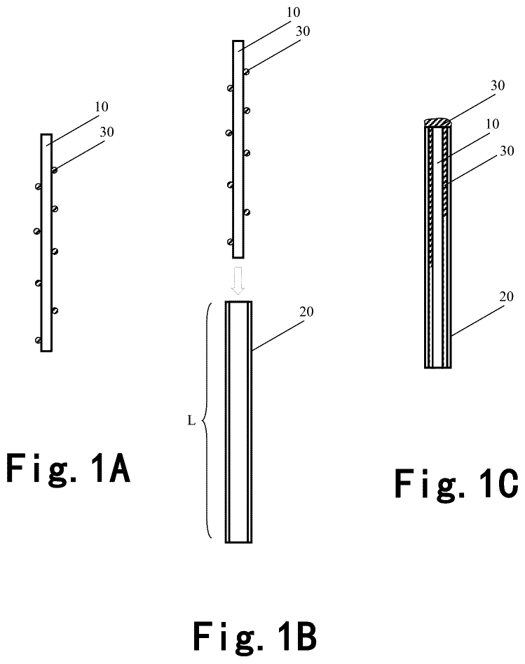

FIGS. 1A to 1C are views schematically illustrating a traditional method for bonding an elongated core into a hollow cylinder by an adhesive. As shown by FIG. 1A, in the traditional method, a certain amount of adhesive 30 is applied onto an outer surface of the elongated core 10. For example, the adhesive 30 can be applied onto the outer surface of the elongated core 10 in such a way that it is distributed spirally on the outer surface of the elongated core 10. Then, in the traditional method, as shown by FIG. 1B, the elongated core 10 with the adhesive 30 applied onto its outer surface will be inserted into the hollow cylinder 20. The hollow cylinder 20 is defined with a hollow interior space for receiving the elongated core 10. The hollow interior space is sized slightly greater than the volume of a part of the elongated core 10 to be inserted into the space. Thereafter, as shown by FIG. 1C, the elongated object 10 is inserted in the hollow interior space of the hollow cylinder 20 to a length L. During the insertion, as a gap between the outer surface of the elongated object 10 and the hollow interior space of the hollow cylinder 20 is very small, most of the adhesive 30 already applied will be blocked out of the hollow interior space of the hollow cylinder 20, especially at an exposed end face of the hollow cylinder 20 adjacent the hollow interior space. Furthermore, if the length L is greater, some of the adhesive 30 even if luckily squeezed into the gap will not be moved further in the gap, resulting in that insufficient adhesive will arrive at a location of the hollow interior space far away from the exposed end face of the hollow cylinder 20. Therefore, after the adhesive 30 in the gap is cured, much more voids will exist in a region to be bonded such that the bonding durability between the elongated object 10 and the hollow cylinder 20 becomes poor. The blocked out adhesive 30 at the exposed end face cannot be recycled for use again and thus will be handled as wastes, causing a great increase in manufacturing costs, especially for mass production.

In order to solve the above issues, the present application proposes a method and/or apparatus for inserting an elongated core into a hollow cylinder and bonding them together. It should be understood by one ordinary person in the art that the method and/or apparatus as explained below is adaptable for inserting one elongated object at least partially into another object or its elongated cavity and bonding both of them securely via an adhesive. Specifically, the method and/or apparatus according to the present application is applicable to manufacturing of styluses, especially those dedicated to touch-screen computers, tablet computers or the like. For instance, a stylus is configured to include a sleeve. A pencil tip is disposed in and exposed at one end of the sleeve, and an elongated metal core is inserted and secured in a hollow interior of the sleeve in such a way that it is coupled to the pencil tip. The metal core is secured in the sleeve using an adhesive (or glue). Therefore, in those embodiments explained below, the elongated core may be understood as the metal core of the stylus and the hollow cylinder may be understood as the sleeve of the stylus. Although the embodiments are explained below with respect to the elongated core and the hollow cylinder, it should be conceived by one ordinary person in the art that the method and/or apparatus according to the present application can be used for any other kinds of elongated objects and relevant objects provided with elongated cavities for receiving the elongated objects.

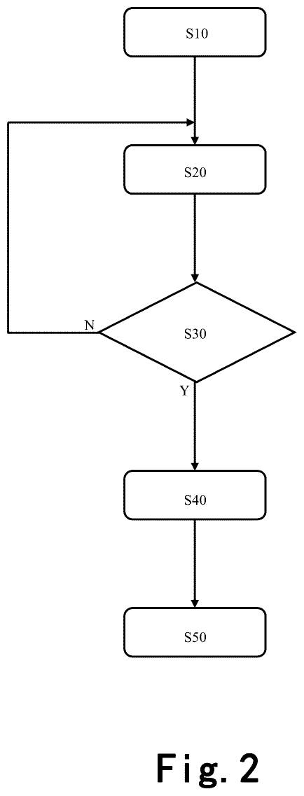

FIG. 2 is a flow chart schematically illustrating a method according to one embodiment of the present application. The method can be used to bond an elongated core into a hollow cylinder via an adhesive (or glue). Here, the hollow cylinder is defined with an elongated cavity for receiving at least a part of the elongated core. Specifically, the elongated cavity of the hollow cylinder is configured to have a closed end and an opposite open end. Therefore, the elongated cavity is able to receive the elongated core via the open end. In the embodiment of the present application, for instance, the elongated core has a circular cross section and the elongated cavity also has a circular cross section. However, it should be understood by one ordinary person in the art that the technical solution of the present application is adapted for an elongated core of other shaped cross section and/or an elongated cavity of other shaped cross section.

As shown, at a step S10, assuming that the elongated core has already been inserted in the elongated cavity of the hollow cylinder in place, a receiving capacity of a gap defined between the elongated cavity and an inserted part of the elongated object is calculated. If the liquid compressibility is ignored, this receiving capacity will represent an amount of the adhesive in its liquid state required for bonding the elongated core together with the hollow cylinder. For instance, if the elongated cavity has an internal diameter D, the elongated core has an external diameter d and the elongated core will be inserted at an insertion depth L (which can be measured in advance before its insertion), it can be determined by geometric calculation that the receiving capacity mentioned above or the amount of the liquid adhesive as required can be obtained by V=(πD²−πd²)·L. Of course, it should be understood by one ordinary person in the art that if the elongated cavity and/or the inserted part of the elongated core is not perfect-cylinder shaped, the above equation could be modified by relevant solid geometry knowledge.

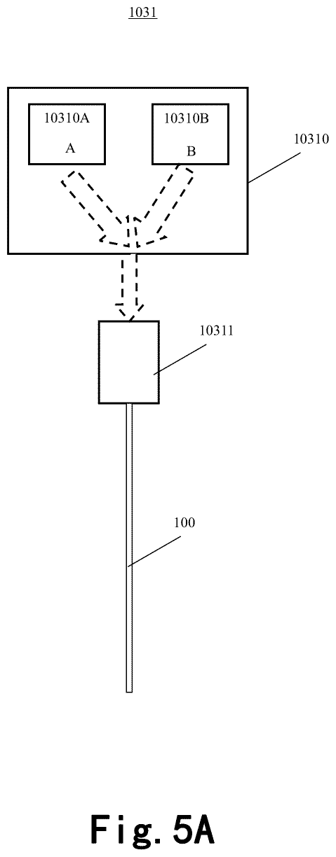

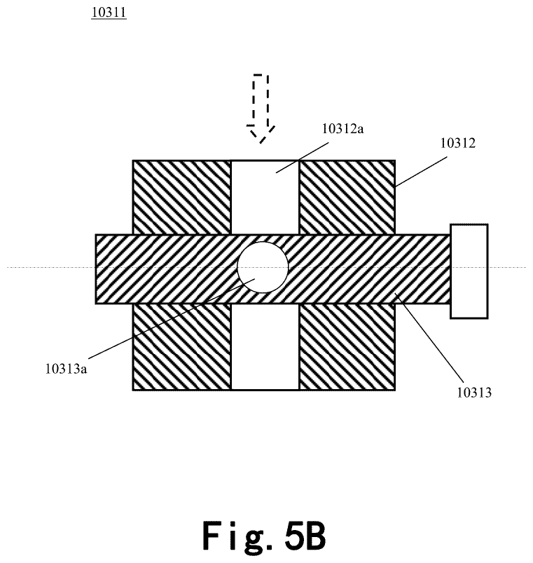

Then, at a step S20, the adhesive in its liquid state is supplied into the elongated cavity of the hollow cylinder. Then, at a step S30, it is determined whether the supplied amount of the adhesive has arrived at the calculated amount of the step S10. For instance, this can be carried out by monitoring a liquid discharging amount of an injection device 1031 (as shown by FIG. 5A) for supplying the liquid adhesive. If the determination result of the step S30 is NO, the method continues to go to the step S20. If the determination result of the step S30 is YES, the method goes to a step S40.

At the step S40, the elongated core can be inserted into the elongated cavity of the hollow cylinder already supplied with the liquid adhesive, arriving at the depth L. Then, at a step S50, the liquid adhesive is cured. For instance, it can be carried out by natural curing or a relevant curing device.

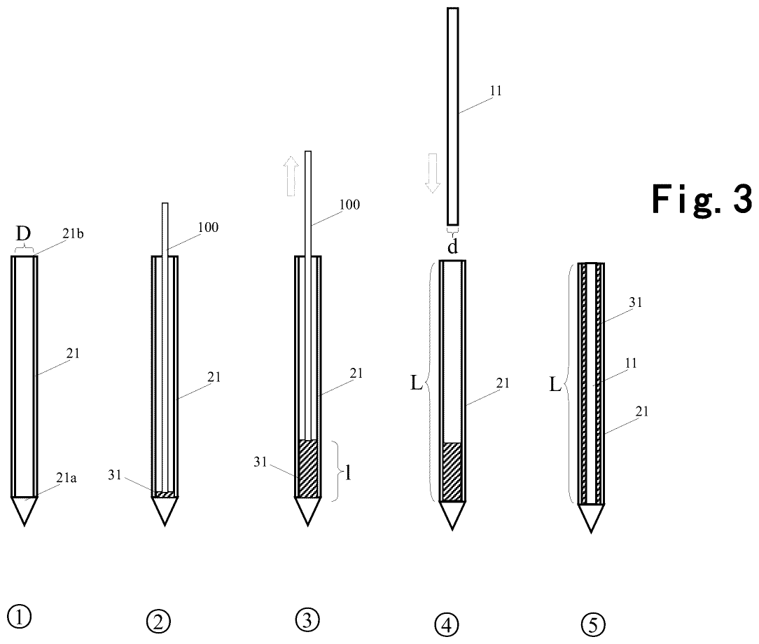

As shown by a section a of FIG. 3, a hollow cylinder 21 is provided. For instance, it can be a sleeve of a stylus. This hollow cylinder 21 is configured to include a closed end 21a and an open end 21b opposite to the closed end. In an optional embodiment, the sleeve of the stylus has an open end portion, which is enclosed by a pencil tip of the stylus to define said open end, and an opposing open end portion to define said open end. The hollow cylinder 21 is defined with an elongated internal cavity between the closed end 21a and the open end 21b. For instance, the cavity of the hollow cylinder 21 has an internal diameter D which can be 7.1 mm (millimeter). Further, as shown by a section 4 of FIG. 3, an elongated core 11 will be inserted by an insertion depth L which can be 150 mm. In an alternative embodiment, the insertion depth can be within a range of 100 to 170 mm and the internal diameter of the cavity can be within a range of 6 to 12 mm. Therefore, after the insertion depth of the elongated core 11 is determined, a receiving capacity of a gap between an inserted part of the elongated core 11, after it is inserted into the elongated cavity of the hollow cylinder 21 by the insertion depth L, and an inner wall of the elongated cavity of the hollow cylinder 21 will be determined through the step S10 for receiving a liquid adhesive of about 490 mg (milligram). In case that the hollow cylinder 21 is empty and stands vertically, a liquid level height I of about 27 mm measured upwards from the closed end 21a of the hollow cylinder 21 can be obtained if the liquid adhesive of about 490 mg is supplied into the hollow cylinder 21 without air bubbles. In the context of the present application, the liquid level height measured upwards from the closed end 21a of the hollow cylinder 21 refers to a liquid level height measured upwards vertically from the most top inner wall of the closed end 21a after the liquid has been supplied in the cavity of the hollow cylinder 21 which is arranged vertically.

Then, as shown by a section 2 of FIG. 3, an injection pipe 100 of the injection device 1031 (as shown by FIG. 5A) for supplying the liquid adhesive 31 is placed to extend into the hollow cylinder 21. According to one example of the present application, for the size specification of the hollow cylinder 21 as shown by the section a, the injection pipe 100 can be embodied as an injection needle sized 16 G and 6 inch. In a preferred embodiment, the hollow cylinder 21 when in its empty state is arranged perpendicular to the ground. The injection pipe 100 is inserted into the cavity of the hollow cylinder 21 along a vertical direction from top to bottom, and a liquid injecting front tip of the injection pipe 100 almost approaches the closed end 21a. For example, the liquid injecting front tip can be spaced from the most top inner wall of the closed end 21a by a distance which is equal to or less than 2 mm. Then, as shown by the section 2 of FIG. 3, a minor amount of liquid adhesive 31 is first supplied in such a way that the liquid injecting front tip of the injection pipe 100 is immersed just under a liquid level of the already supplied liquid adhesive. For example, the already supplied liquid adhesive may enable the liquid level height measured upwards from the closed end 21a of the hollow cylinder 21 to be about 2 mm. This is advantageous in that in most cases the inner wall of the closed end 21a of the hollow cylinder 21 is not smooth enough, supplying the minor amount of liquid adhesive at a location spaced from the closed end 21a by the distance will ensure that the liquid injecting front tip of the injection pipe 100 can be always immersed in the injected liquid adhesive such no air bubble will enter the liquid adhesive if an additional amount of liquid adhesive is supplied. Otherwise, air bubbles if entering will result in adverse void phenomenon after curing of the liquid adhesive.

Then, a relative movement between the hollow cylinder 21 and the injection pipe 100 is performed along a direction parallel to a longitudinal axis of the injection pipe 100 such that the hollow cylinder and the injection pipe are kept away from each other. For instance, this can be carried out by enabling one of the hollow cylinder and the injection pipe to be stationary and moving the other along a direction parallel to their longitudinal axes. It is conceived that a relative movement between two features can also refer to that both of the two features are moved relative to each other. During the relative movement between the hollow cylinder 21 and the injection pipe 100, the liquid adhesive is supplied by the injection pipe 100 at a given flow rate. It should be understood that a moving velocity, at which the hollow cylinder and the injection pipe are configured to be kept away from each other, and the flow rate, at which the liquid adhesive is supplied by the injection pipe 100, are chosen in such a way that the liquid injecting front tip of the injection pipe 100 is always immersed immediately under the liquid adhesive's liquid level. In a preferred embodiment, the moving velocity of away from each other and the flow rate of the liquid adhesive injected by the injection pipe 110 are uniform, slow, and constant. In this way, after the liquid level height I becomes about 27 mm (as shown by a section 3 of FIG. 3), the injection pipe 100 is left completely away from the hollow cylinder 21. It should be understood that during the injection of the liquid adhesive 31, the injection pipe 100 or its liquid injecting front tip is held in such that the pipe or the tip is not in contact with the inner wall of the cavity of the hollow cylinder 21. That is to say, as the liquid level height I becomes greater, any liquid adhesive if supplied will first go under the liquid's level such that at any time a part of the cavity above the liquid's level cannot contact any liquid adhesive. The contents relevant to the sections 2 and 3 of FIG. 3 substantially correspond to the steps S20 and S30 respectively.

Then, as shown by the section 4 of FIG. 3, according to the step S40, the elongated core 11 is inserted vertically from top to bottom, via the open end 21b, into the cavity of the hollow cylinder 21 already supplied with the liquid adhesive. Because the already supplied liquid adhesive is located adjacent the closed end 21a and far away from the open end 21b, the liquid adhesive will be squeezed upwards, due to its incompressibility, towards the open end 21b along the gap between the outer surface of the elongated core 11 and the inner wall of the cavity as an end of the elongated core 11 becomes approaching the closed end 21a. The amount of the liquid adhesive already supplied is calculated in advance to be just enough to fully fill the gap between the outer surface of the elongated core 11 and the inner wall of the cavity when the elongated object 11 is in the cavity in place. Therefore, when the elongated core 11 is inserted in the cavity in place (to the depth L), the gap between the outer surface of the elongated core 11 and the inner wall of the cavity is just full of the liquid adhesive. Alternatively, even if some liquid adhesive may be spilled out due to calculation error, the spilled liquid adhesive will not be too much as wastes. More importantly, due to the liquid's incompressibility, the liquid adhesive will be dispensed evenly between the outer surface of the elongated core 11 and the inner wall of the cavity so as to avoid adverse void phenomenon as much as possible.

According to an embodiment of the present application, before the elongated core 11 is inserted into the hollow cylinder 21, it is ensured that no liquid adhesive exists on the inner wall of the cavity between the already supplied liquid adhesive's liquid level and the open end 21b. This will guarantee that only the already supplied liquid adhesive will be moved towards the open end 21b along the gap by the squeezing of the elongated core 11. In this way, when the elongated core 11 is inserted in the hollow cylinder 21 at the depth L in place, no excessive liquid adhesive will be discharged out of the hollow cylinder 21. In a preferred embodiment, during the insertion, the longitudinal central axis of the elongated core 11 is always coaxial with the longitudinal central axis of the hollow cylinder 21.

It can be seen that using the method of the present application, the liquid adhesive is able to be supplied with a less amount and be dispensed more evenly in the gap between the elongated core 11 and the hollow cylinder 21 such that after the adhesive is cured, the void phenomenon will be avoided to obtain an improved bonding effect.

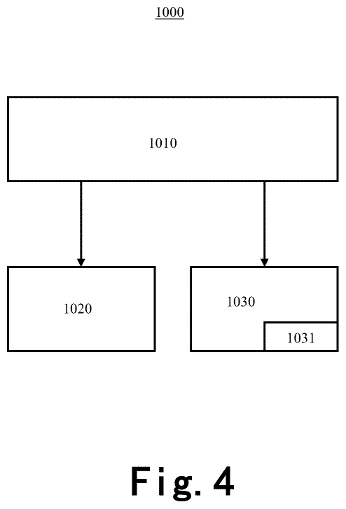

It should be understood by one ordinary person in the art that the method according to the present application can be carried out by an apparatus of any suitable form and/or suitable configuration. FIG. 4 is a view schematically illustrating an apparatus according to one example of the present application. However, the apparatus according to the present application is not limited to the contents explained below. For instance, the apparatus 1000 is configured to include a control module 1010, an operating module 1020 and an adhesive injecting module 1030. The control module 1010 is for example configured to include an electronic control unit such as a computer and a memory for storing programs executable by the electronic control unit. The method or the steps of the method already explained can be coded and stored as programs in the memory, which programs can be invoked and executed by the electronic control unit as desired. The operating module 1020 is configured to hold and/or manipulate the elongated core and the hollow cylinder, as mentioned above, so as to perform the relative movement therebetween. For instance, here, the elongated core can be called as a first object and the hollow cylinder can be called as a second object. For instance, the operating module 1020 can be provided with a first robot arm configured to hold the first object and a second robot arm configured to hold the second object. As desired, any one or both of the first and second robot arms can be moved relative to each other. Furthermore, the adhesive injecting module 1030 is configured to include the injection device 1031, already mentioned, configured to inject or supply the liquid adhesive. It is conceivable that the injection device 1031 itself can be provided with a drive mechanism (not shown) by which the injection device can be moved as desired. The control module 1010 is in data connection with the operating module 1020 and the injection module 1030 in such a way that the operating module 1020 and the injection module 1030 are controllable to carry out respective operations. Of course, it should be understood by one ordinary person in the art that the apparatus 1000 is also configured to include a curing device (not shown) by which the liquid adhesive can be cured.

The method of the present application requires that a certain amount of liquid adhesive is supplied into the cavity of the hollow cylinder as the second object, and then the elongated core as the first object is inserted there such that the supplied liquid adhesive can be filled between the two objects without spillage. Therefore, the amount of the liquid adhesive supplied in the cavity is desired to be very precise. Furthermore, the supplying of the liquid adhesive may be carried out by injection needles of different sizes. This will require that the size of the last liquid droplet at the end of the supplying of the liquid adhesive from the injection needles has to be strictly controlled, and should not be too large. Otherwise, the last liquid droplet at the end of the supplying, if having an overlarge size, will result in that the amount of the liquid adhesive finally supplied into the cavity goes beyond a predefined amount and then, after the elongated core is inserted later, too excessive liquid adhesive will be unexpectedly squeezed out as wastes.

Generally, as shown by FIG. 5A, the injection device 1031 is configured to include a liquid storage device 10310, an adhesive valve 10311 coupled via a pipeline to the liquid storage device 10310 downstream of the liquid storage device 10310, and the injection pipe 100 in fluid communication with the adhesive valve 10311 downstream of the adhesive valve 10311. According to an embodiment of the present application, the injection device 1031 can be configured to supply a two-component liquid adhesive. In this case, the liquid storage device 10310 can be configured to include a first liquid storage part 10310A, in which a liquid component A is received, and a second liquid storage part 10310B, in which a liquid component B is received. The two parts are in fluid communication with the adhesive via a pipe or pipes in such a way that as desired, the liquid component A from the first liquid storage part 10310A and the liquid component B from the second liquid storage part 10310B, after being mixed with each other, can be supplied through the adhesive valve 10311. The adhesive valve 10311 is configured to selectively enable or disable a liquid delivery passage between the injection pipe 100 and the liquid storage device 10310. Therefore, by reasonably designing the configuration of the adhesive valve 10311, the shape and/or size of the last liquid droplet from the injection pipe 100 at the end of the supplying of the liquid adhesive can be determined.

A conventional adhesive valve generally comprises a valve body and a movable valve element. A hollow passage is defined in the valve body to supply a liquid adhesive. Furthermore, the valve element is arranged such that it is linearly movable coaxially with or parallel to a central axis of the hollow passage. Furthermore, one end of the valve element is provided with a clog feature capable of blocking the passage. Therefore, when the passage's opening is closed by the clog feature, the liquid adhesive is prevented from being supplied via the injection pipe 100; and when the opening of the passage is not closed by the clog feature, the liquid adhesive is allowed to be supplied via the injection pipe 100. This conventional adhesive valve is disadvantageous in that a direction, along which the valve element is moved to enable the passage opening to be open or closed, is consistent with a direction, along which the liquid adhesive is able to flow and thus when the passage opening is desired to be closed to stop the supplying of the liquid adhesive, it is very difficult to control the size of the last liquid droplet (in most cases the last liquid droplet will be sized larger than desired) such that the amount of the supplied liquid adhesive cannot be precisely metered. The amount of the liquid adhesive supplied into the cavity of the hollow cylinder 21 is controlled finally by the adhesive valve. If the size of the last liquid droplet cannot be precisely controlled by the adhesive valve, an excessive amount of liquid adhesive is prone to being supplied into the cavity of the hollow cylinder 21, causing subsequent spillage of the redundant liquid adhesive when the elongated core 11 is inserted.

For solving the above issues, FIG. 5B is a cross-sectional view schematically illustrating one example of the adhesive valve 10311 which can be used in the apparatus of the present application, especially the injection device 1031, wherein the adhesive valve 10311 is shown in its disabling mode. The adhesive valve 10311 is generally configured to include a valve body 10312 and a valve element 10313. A passage 10312a for delivering a liquid adhesive is defined in the valve body 10312. This passage 10312a is connected downstream of the liquid storage device 10310 via a pipe. The valve element 10313 is installed to intersect through the passage 10312a. A part of the valve element 10313 in the valve body 10312 is cylinder-shaped. The cylinder-shaped part is rotatable about its own central axis in the valve body 10313. In the meanwhile, the central axis of the cylinder-shaped part is coplanar with a longitudinal central axis of the passage 10312a, and the cylinder-shaped part has a diameter which is sized such that an outer surface of the cylinder-shaped part is able to completely obstruct an open cross-section of the passage 10312a. Additionally, in the valve body 10313, a penetrating feature 10313a such as a though hole, a cutting feature or the like can be formed at an intersection of the cylinder-shaped part with the passage 10312a. When the valve element 10313 is rotated to a given position (for example into an enabling mode of the adhesive valve), the penetrating feature 10313a will enable the passage 10312a to be open such that the liquid adhesive is allowed to flow through the passage. However, when the valve element 10313 is rotated to another position (for example into the disabling mode of the adhesive valve), the passage 10312a will be closed by a part of the valve element 10313 other than the penetrating feature 10313a such that the liquid adhesive is forbidden to flow through the passage. It should be understood that under control of the control module 1010, the valve element 10313 can be rotated correspondingly and stopped to any desired position.

As the valve element 10313 is configured to be transverse to the passage 10312a and be rotatable, the adhesive valve 10311 if desired can be very quickly switched into its disabling mode in which the passage 10312a is closed. The size of the last liquid droplet can be controlled more precisely than the conventional adhesive valve. Therefore, the adhesive valve 10311 is more adaptable to be used in the apparatus of the present application.

Although some specific embodiments and/or examples of the present application are described here, they are given for illustrative purposes only and cannot be deemed to constrain the scope of the present application in any way. Furthermore, it should be understood by the ordinary person in the art that the embodiments and/or examples described here can be arbitrarily combined with each other. Without departing from the spirit and scope of the present application, various replacements, modifications and alternations can be thought out.

1: A method for bonding a first object with a second object, the first object being elongated, the second object being defined with a cavity configured to receive at least a length of the first object, the cavity having a receiving capacity which is slightly greater than a volume of the first object to be inserted into the cavity, and the cavity being configured to include a closed end and an opposite open end, the method comprising:
determining an amount of liquid adhesive to be supplied into the cavity on the basis of the difference between the receiving capacity of the cavity and the volume of the first object to be inserted into the cavity in place;
placing the second object in such a way that the closed end is on bottom and the open end is on top;
supplying the determined amount of liquid adhesive into the cavity in such a way that the supplied liquid adhesive is collected at the closed end;
inserting at least a part of the first object into the cavity via the open end in such a way that one end of the first object approaches or contacts the closed end; and
curing the liquid adhesive.

2: The method according to claim 1, wherein inserting an injection pipe into the cavity to supply the liquid adhesive into the cavity; and removing the injection pipe from the cavity before the first object is inserted into the cavity.

3: The method according to claim 2, wherein at the start of supplying the liquid adhesive into the cavity, a liquid injecting front end of the injection pipe is placed adjacent the closed end in such a way that a minor amount of liquid adhesive is first supplied into the cavity.

4: The method according to claim 3, wherein with continuously supplying the liquid adhesive, a relative movement between the second object and the injection pipe is carried out in such a way that the closed end becomes far away from the liquid injecting front end and the liquid injecting front end is immersed always under the supplied liquid adhesive's liquid level.

5: The method according to claim 4, wherein after the determined amount of liquid adhesive has been supplied into the cavity, no liquid adhesive exists on an inner wall of the cavity above the liquid level.

6: The method according to claim 5, wherein the first object is inserted into the cavity in such a way that a longitudinal central axis of the first object is coaxial with a longitudinal central axis of the cavity.

7: The method according to claim 6, wherein the first object is a metal core of a stylus, the closed end of the receiving cavity is defined by a pencil tip of the stylus, and the second object is a sleeve of the stylus.

8: The method according to claim 7, wherein the cavity has a length and an internal diameter, the length is within a range of 100 to 170 mm and the internal diameter is within a range of 6 to 12 mm, and the injection pipe comprises an injection needle sized 16 G and 6 inch; preferably, wherein the length of the cavity is 150 mm and the internal diameter of the cavity is 7.1 mm.

9: The method according to claim 1, wherein the second object is a hollow cylinder, which hollow cylinder is configured to include an open end portion, which is enclosed by another object to define the closed end, and an opposing open end portion to define the open end.

10: An apparatus for bonding a first object with a second object, the first object being elongated, the second object being defined with a cavity configured to receive at least a length of the first object, the cavity having a receiving capacity which is slightly greater than a volume of the first object to be inserted into the cavity, and the cavity being configured to include a closed end and an opposite open end, the apparatus comprising:
a control module configured to store and execute a program for carrying out a method according to claim 1;
an operating module configured to be in data connection with the control module and be controllable by the control module;
an adhesive injecting module configured to be in data connection with the control module and be controllable by the control module, wherein the adhesive injecting module comprises an injection device by which the liquid adhesive is able to be supplied into the cavity.

11: The apparatus according to claim 10, wherein the injection device comprises:
a liquid storage device for storing the liquid adhesive;
an adhesive valve coupled via a pipe to the liquid storage device downstream of the liquid storage device; and
an injection pipe configured to be in fluid communication with the adhesive valve downstream of the adhesive valve.

12: The apparatus according to claim 11, wherein the adhesive valve is configured to include a valve body and a valve element, a passage is defined in the valve body to deliver the liquid adhesive, the valve element is installed to intersect through the passage and is configured to be rotatable about its own longitudinal central axis between a first position, in which the liquid adhesive is allowed to flow through the passage, and a second position, in which the liquid adhesive is forbidden to flow through the passage.

13: The apparatus according to claim 12, wherein the first object is a metal core of a stylus, the closed end of the receiving cavity is defined by a pencil tip of the stylus, and the second object is a sleeve of the stylus.

14: The apparatus according to claim 13, wherein the cavity has a length and an internal diameter, the length is within a range of 100 to 170 mm and the internal diameter is within a range of 6 to 12 mm, and the injection pipe comprises an injection needle sized 16 G and 6 inch; preferably, wherein the length of the cavity is 150 mm and the internal diameter of the cavity is 7.1 mm.

15: A stylus which is produced by an apparatus according to claim 1.
